(19) United States
(12) Patent Application Publication
(10) Pub. No.: US 2018/0285943 A1
(43) Pub. Date: Oct. 4, 2018

(54) ECOMMERCE FOR CHARITY UTILIZATION PROCESS

(71) Applicants: John Carmine Casalinuovo, New York, NY (US); Cierra Rose Mazzola, New York, NY (US)

(72) Inventors: John Carmine Casalinuovo, New York, NY (US); Cierra Rose Mazzola, New York, NY (US)

(21) Appl. No.: 15/925,239

(22) Filed: Mar. 19, 2018

Related U.S. Application Data
(60) Provisional application No. 62/480,211, filed on Mar. 31, 2017.

(51) Int. Cl. G06Q 30/02; G06Q 30/06

(52) U.S. Cl. CPC G06Q 30/0279; G06Q 30/0601

(57) ABSTRACT

The present invention correlates to the method of making practical and effective use of eCommerce for the generation of donations to highly rated charities. Furthermore, this invention more specifically relates to the process of enabling consumers to act as catalyst for generating monetary donations to highly assessed charities, simply by shopping online by way of this particular process. “eCommerce For Charity Utilization Process” comprises a method of generating funds for charity based on consumers eCommerce sales. The present invention is a process that utilizes eCommerce to donate to charity though affiliate programs.

### INVENTION INTRODUCTION

To Whom It May Concern: Be it known that John Carmine Casalinuovo and Cierra Rose Mazzola, both residents of the Little Italy-Chinatown neighborhood of New York City in the United States of America, have invented a process to generate donations to highly rated charities by utilizing eCommerce activity. This invention is entitled “ECOMMERCE FOR CHARITY UTILIZATION PROCESS” and is described in the following specification.

### CROSS-REFERENCES TO RELATED APPLICATIONS

This application is a continuation of a provisional patent application, of the invention entitled “ECOMMERCE FOR CHARITY UTILIZATION PROCESS,” correlating to U.S. application Serial Number 62488,0211; filed Mar. 31, 2017 via EFS Web ID 28807038.

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING COMPACT DISC APPENDIX

Not Applicable.

### FIELD OF THE INVENTION

The present invention entitled “eCommerce For Charity Utilization Process” correlates to the process of making practical and effective use of eCommerce for the generation of donations to highly rated charities. Furthermore, this invention more specifically relates to the process of enabling consumers to act as catalyst for generating monetary donations to highly assessed charities, simply by shopping online by way of this particular process.

### BACKGROUND

Charity has been a realm of importance throughout human history. Babylonians of yore reserved especially severe punishments for those charged with mistreating or abusing the weak. Ancient Egyptians believed that any cruelty towards the suffering during life could detrimentally impact the afterlife. Nowadays suffering continues and has become a systemic epidemic, thus prevalence of philanthropy remains strong. Earth's skies, lands, oceans, and rivers are polluted nearly beyond comprehension. Animals are being abused, poached, starved, and pushed from their habitats: into extinction. Even human beings face poverty, starvation, live in squalor and ultimately lead unhealthy existences. In fact, according to United Nations: “795 million people in the world do not have enough food to lead a healthy active life.” While methods exist to help support charities and help combat this suffering epidemic, there's vast need for improvement.

Traditionally there's a few methods available to philanthropists in order to help support charities. The two most common options are to either: contribute time or contribute money. Generally, contributing time requires a charity supporter be physically present at a specified location(s) to volunteer, but occasionally may only involve a virtual presence on the internet. The drawback to this method is that many people are unable to volunteer, simply due to responsibilities that limit free time. Making monetary contributions towards a cause is commonly completed by way of the internet but also by mail. To make a donation online entails using the internet to access the website of a specific charity, then donating with a debit/credit card in specified areas. Donating by mail involves mailing a check or money order directly to a specific charity location or mailing address. Online or by mail, either can be done once or on a regular basis. The issue with this method is that a enormous amount of people are restricted financially, thus are unable to directly donate to charity, despite any desire to do so.

Following the two traditional methods previously described, another was developed in the same field. The method entails the purchase of gift cards by online consumers on a specific website, from which a portion of the proceeds received (from the purchase of the gift card) is donated to a charity. A disadvantage to that method is that while gift cards can be used in many locations, the requirement to purchase one before making any other purchases is fairly restrictive. Another issue is that this method offers little variety to online consumers in relation to charity selection options. While this method certainly represents improvements in the field by enabling financially restricted individuals to generate funds for charity in the aforementioned manner, changes are still necessary. Thus, a need for advancement in the capability to enable individuals of all social classes to participate in the field of philanthropy, still exists.

### BRIEF SUMMARY OF THE INVENTION

The present invention consists of specific method that allows individuals to shop online to generate money that supports a variety of highly rated charities (or a single charity if chosen), at no additional cost or fee to the online purchase. To complete the herein process, access to a sufficiently charged and “powered-on” computer or smart phone, with secure internet access (i.e. WiFi connection) is required. Through either of the aforementioned requirements, this process may be completed through a website or mobile application, where various online stores and highly assessed charities will be available to select by consumers. Due to the rampancy of fraudulent charities, all included charities are sufficiently vetted before admittance. If a consumer wants to the money generated from their purchase to go to all the charities equally, there are three steps. Simply described: upon arriving at the invention's website or mobile application, a individual shopper selects a online store by clicking a specified link (i.e. affiliate program). After clicking the link of the online store, a consumer shops and checks out. Automatically all highly charities will benefit from the online purchase if none is selected. For an individual to select a single charity to benefit from their online purchase, there are six steps. The steps to select a single charity are: Upon arriving at the invention's website or mobile application, a individual shopper selects a online store by clicking a specified link (i.e. affiliate program). After clicking the link of the online store, a consumer shops and checks out. While checking out, the online shopper copies (i.e. take note of) the subtotal (i.e. cost of items in a shopper's order, excluding taxes or shipping) from the receipt. Next the online shopper returns to the website or mobile application of the invention and selects a charity to reap the benefit from the purchase made. In preferred embodiments, the various elements of the herein process are each configured on a website and/or mobile application to serve as portals in order to effectively use this process.

### BRIEF DESCRIPTION OF THE DRAWINGS

Some embodiments of the present invention are illustrated as an example, and are not limited by the figures, terms, drawings or images of the accompanying drawings described herein. This invention is designed to be operated by using the internet through a computer or smart phone, thus these accompanying drawings include depictions of such components. Furthermore, these aforementioned components are presumed to be already sufficiently charged and “powered-on” in the upcoming descriptions. These drawings are not necessarily drawn to scale, and various references may include corresponding elements. Such illustrations and elements will now be referenced:

FIG. 1 depicts a flow chart that imparts multiple courses of action for function, according to various embodiments of the present invention.

FIG. 2 illustrates a diagram of a laptop, from a frontal perspective view, displaying one example of the present invention according to various elements and embodiments described herein.

FIG. 3 shows a diagram of a laptop, from a frontal perspective view, displaying one example of the present invention according to various elements and embodiments described herein.

FIG. 4 displays a diagram of a laptop, from a frontal perspective view, displaying two different examples of the present invention according to various elements and embodiments described herein.

FIG. 5 illustrates a diagram of a laptop, from a frontal perspective view, displaying one example of the present invention according to various elements and embodiments described herein.

FIG. 6 depicts a diagram of a smart phone, from a frontal perspective view, displaying one example of the present invention according to various elements and embodiments described herein.

FIG. 7 shows a diagram of a smart phone, from a frontal perspective view, displaying one example of the present invention according to various elements and embodiments described herein.

FIG. 8 displays a diagram of a smart phone, from a frontal perspective view, displaying one example of the present invention according to various elements and embodiments described herein.

FIG. 9 depicts a diagram of a smart phone, from a frontal perspective view, displaying one example of the present invention according to various elements and embodiments described herein.

### DETAILED DESCRIPTION OF THE INVENTION

The phrasing, expressions, or terminology used in this specification is intended to describe specific embodiments and/or directions for use of this particular process and is not intended to limit the invention. Used herein, this term “and/or” includes any and all combinations of one or more of the associated listed items. As used herein, the singular terms “the,” “a,” and “an” are intended to include the plural forms as well as the singular forms, unless the context expressly states other side. It's to be further understood that the terms “comprising,” and/or “comprises” when used herein, specify the presence of expressly stated features, steps, operations, elements and/or components, but do not preclude the presence or addition of one or more other features, steps, operations, elements components and/or groups. All terms (including technological, virtual, technical or scientific) used in this specification have the same meaning as commonly understood by one having ordinary skill in this field to which this invention belongs, unless otherwise defined. Furthermore, it will be understood that terms such as the ones defined in ordinary dictionaries, should be interpreted as having a meaning that's consistent with the meaning in the present disclosure and context of the relevant art, and will not be interpreted in an overly formal fashion or in an idealized sense, unless defined herein explicitly.

To describe this invention, it will be acknowledged that a number of steps and techniques are disclosed in this specification. Each individual one has advantages and each may also be used in convergence with one or more or in some cases all, of the other disclosed steps and techniques. Therefore, for the sake of lucidity, this description will abstain from repeating every possible combination of the individual steps in an unnecessary manner. Nonetheless, this present specification and claims should be read with the understanding that such combinations or possible collaborations are completely within the scope of the invention and claims. A new process for utilizing eCommerce for charitable donations is discussed herein. For purposes of providing a thorough and transparent explanation, the following description states numerous details for use of the present invention. To one skilled in the art of the field of which the present invention lies, it will be apparent that it may be practiced without these particular details covered in this specification.

The present disclosure is to be regarded as an example of the present invention, and isn't intended to limit the invention to the specific embodiments displayed by the figures, terms or descriptions herein. To describe the present invention, references and appended figures have been provided in order to represent preferred embodiments. Completing the herein process, requires access to a sufficiently charged and “powered-on” computer or smart phone, with secure internet access (i.e. WiFi connection). As a result, the upcoming appended figures, descriptions and references have been created under the presumption such requirements have been fulfilled prior to the start of this process.

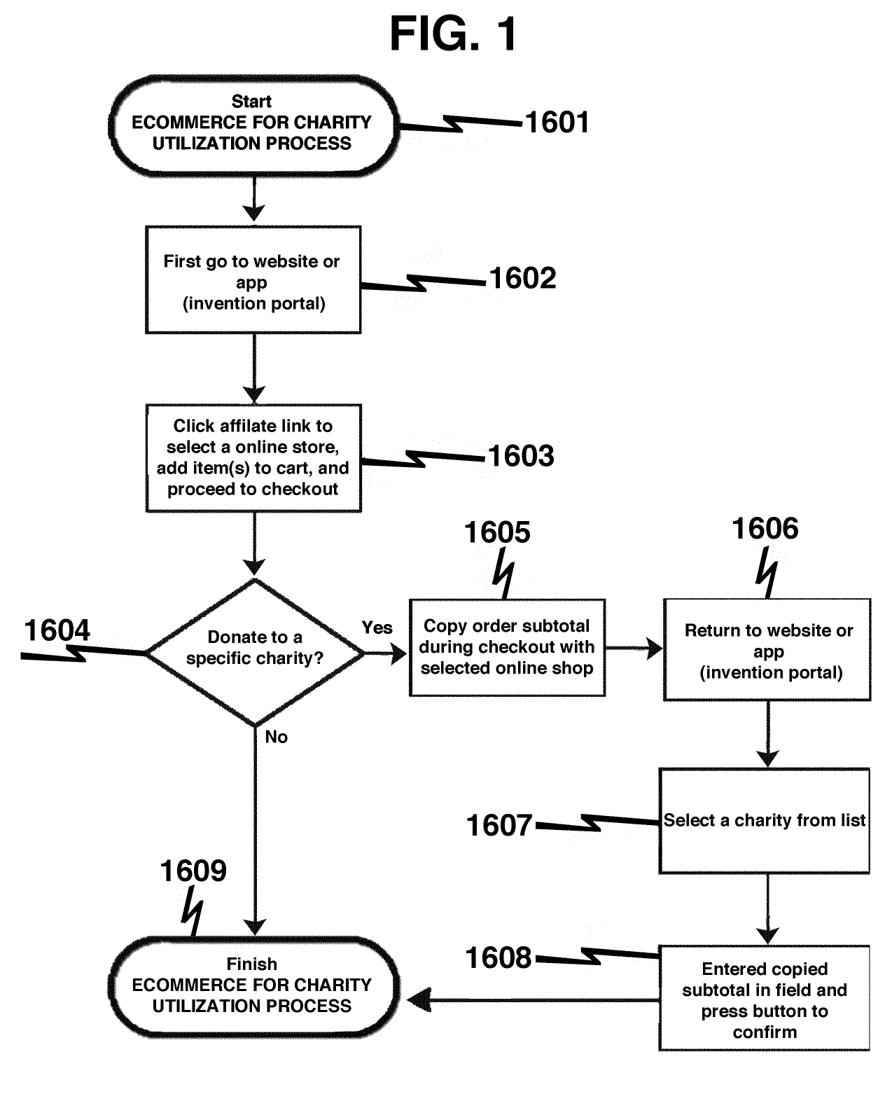

Perhaps the simplest method of conveying various embodiments and elements of this invention, are depictions shown in FIG. 1. Integrated into FIG.1 are components from all of the accompanying figures. Demonstrated in FIG. 1 is a flow chart imparting a specific process, entwined with two distinct options for use, according to various embodiments of the present invention. The routes for completion of either aforementioned option is described in FIG. 1 in a series of steps. 1602, the first step, calls for an individual to go to a portal of this invention: a website or mobile application. Step 1603 entails a user shop online by clicking the affiliate links conspicuously provided on the website or mobile application. When the user is finished adding items to cart on an affiliate's online store/website, next proceed to check out. Afterwards, a crossroads arrives, and a course of action must be decided. Labeled 1604 in the flow chart, it's inquired whether one specific charity should benefit from the eCommerce that occurred in the prior step. If the answer is “no,” then conclude checking out and the process is considered completely finished, thus all charities will be donated to equally. Answer “yes,” and there's additional steps required to choose a particular charity.

The following steps to select a single charity to benefit from the present process are simply described in this paragraph. To select a single charity, the next step 1605 requires a user copies their subtotal (cost of items in a purchase, excluding taxes and shipping.) In preferred embodiments, the order subtotal is copied during checkout, although it can also be copied/noted following checkout if necessary. Step 1606 involves returning to the website or mobile application (invention portal) originally referenced in step 1602, to view the noticeably supplied array of charities to choose from. After considering the various charities, the following step 1607 requires user select a single charity from the list. Finally the user enters the copied/noted subtotal (i.e. step 1605) in a well defined, conspicuous field, and presses a button directly below to confirm the charity selection. The process for utilization of eCommerce for charity is now complete as shown at the end point numbered 1609 in FIG. 1.

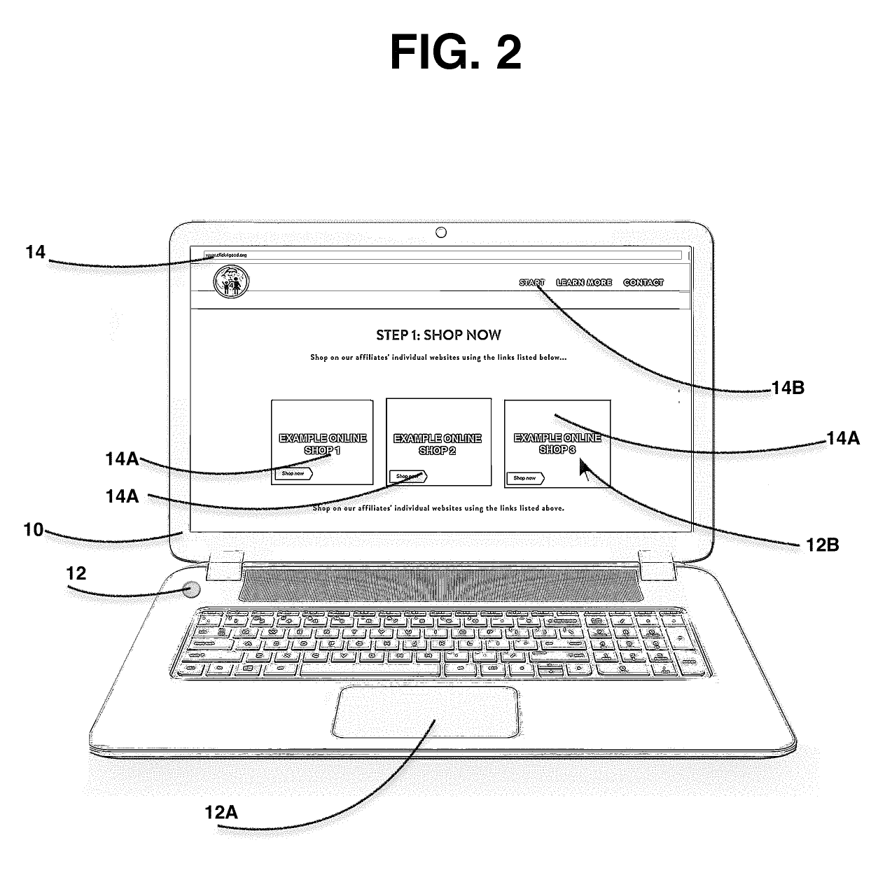

The next figure, FIG. 2 illustrates a diagram of a laptop 10, from a frontal perspective view, displaying one example of the present invention according to various elements and embodiments. Depicted on the screen of the laptop 10, is a website 14, which makes the invention accessible to users. In all accompanying figures and drawings, the laptop 10 is already “powered on” by way of the power button 12 as well as connected to the internet. Note the trackpad 12A, may be subject to slight variations depending on brand of laptop. The trackpad is similar to a mouse on a desktop computer and is clearly directly connected to the cursor arrow 12B. Using 12A to control 12B is used to make various selections, including shopping with affiliates using affiliate links 14A. These affiliate links 14A are part of affiliate programs associated to various businesses with an online store/website. These programs help enable this invention to function, as a portion of these funds generated from commissions received from these programs are donated to the charities. The start button 14B is provided at the top of the website help individuals using the invention to find a selection of online stores and charities at any time. FIG. 2 conveys the various embodiments and elements associated with the beginning step of the present process. This figure directly corresponds with step 1602 in the flowchart displayed in FIG. 1, and expresses the visual experience from a user's perspective. A user of the present invention first enters a website in the url field supplied in all web browsers, where this invention will be accessible. Next the invention user selects a online store 14A from the conspicuously options provided in the form of affiliate links. A user clicks on one of these affiliate links 14A, to proceed to the next step of the present invention.

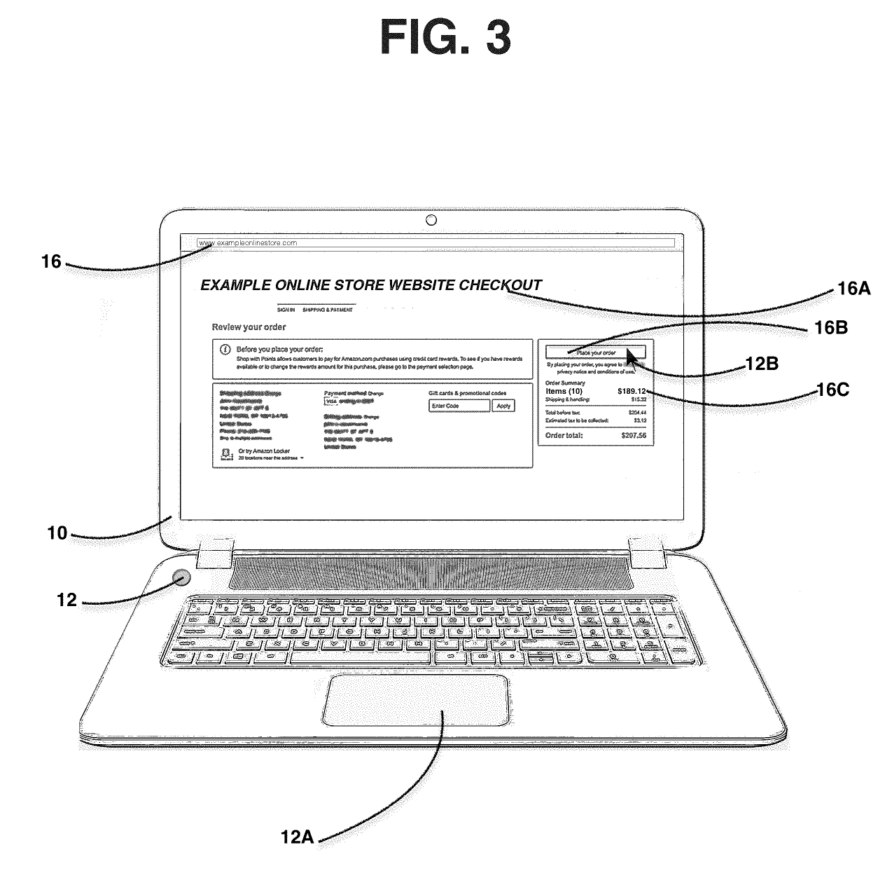

While continuing to elaborate on the subject matter discussed in earlier paragraphs, FIG. 3 also corresponds directly to step 1603 from the previously displayed FIG. 1 flow chart. FIG. 3 illustrates a diagram of a laptop 10, from a frontal perspective view, displaying one example of the present invention according to various elements and embodiments. This figure is also noteworthy because in addition to it's correspondence with step 1603 in FIG. 1, it also directly connects to stage 1604, and step 1605, from the same figure. In preferred embodiments of the present process, an individual consumer selects one or more products to purchase from the online store of the affiliate link 14A chosen/clicked on in the previous figure, FIG. 2. Shown on the screen of the laptop 10, is an affiliate website 16 and it's corresponding checkout page 16A. All normal features expected of a general online checkout page are included such as the “Place Your Order” button 16B and order subtotal (cost of items) 16C. Now relating to stage 1604 from FIG. 1, there's two options for an individual at this stage of the process. The present process can either be concluded following checkout, or it can proceed further based on a user's preferences. If a individual selects to conclude this process at this stage, checkout (payment for one item or more), is required. Using the cursor 12B to confirming the purchase by clicking the conspicuously placed button will conclude the process. Completing the process at this stage results in all charities on the list being donated to equally. The first manner of completing this process, on a laptop computer, has been described thoroughly and thus will conclude for the time being. To continue the alternative manner of completing this process, continue reading herein. If a individual's preference is to select a individual charity to be donated to, there's additional steps required. Decision to complete the present process in this fashion, relates directly to step 1605 of the FIG. 1 flow chart. In preferred embodiments, to continue this process and select a single charity, a user must simply use the cursor 12B to highlight then copy (keyboard buttons: command+C) the order subtotal 16C, or just note it by hand on a piece of paper, right before or following checkout. The subtotal 16C is the cost of the items without taxes or shipping, which affiliate programs do not grant commissions for, thus those costs cannot be included in the donation process. In FIG. 3, the embodiment portrays the online order subtotal 16C as “$189.12” but could be any amount of money. The various embodiments and elements expressed in the upcoming paragraphs relate directly to completion of the present process in this fashion. The drawing presented in FIG. 3 show some of the same elements and features noted as 10, 12, 12A, and 12B in the previous paragraph and figures in regards to laptop/computer and mouse/trackpad properties, functionality information and the like, thus repetition will be avoided to prevent redundancy.

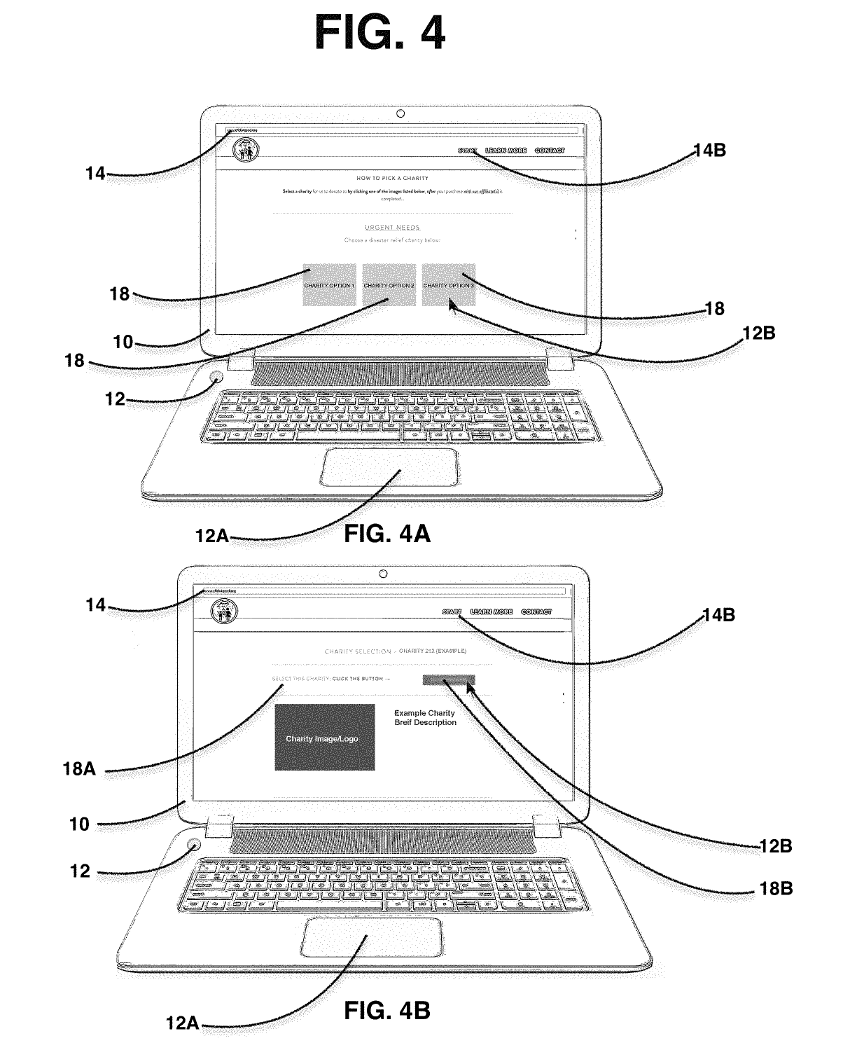

In preferred embodiments, only three additional steps are required to complete the process in it's entirety, in this alternative manner. FIG. 4 directly connects to step 1606 and 1607 from the flow chart displayed in FIG. 1. Illustrating a diagram two laptops 10, from a frontal perspective view, FIG. 4 displays two examples of the present invention according to various elements and embodiments. The two examples will be labeled FIG. 4A and FIG. 4B to avoid any possible confusion. FIG. 4A relates directly to step 1606, while FIG. 4B corresponds to step 1607 of the flowchart of FIG. 1. In preferred embodiments, an individual consumer proceeds to select a charity by returning to the original website 14, a portal to the present invention, expressed also in a diagram in FIG. 2 and also in step 1602 of the flow chart in FIG. 1. Various links, easily perceptible to the human eye, such as link 14B at the top right corner of the page is supplied to quickly alert consumers to the correct area of the website of which to select a charity, furthermore for convenience, charity selection is also enabled on the main/home page directly resting under the affiliate links 14A, of the website 14 (invention portal). After clicking a link such as 14B or just scrolling past the affiliate links 14A on the main page 14, a user is presented with a variety of charity options 18 to select from. In FIG. 4A, displayed on the screen of a laptop 10 are charity options 18 available for selection. Each charity option 18 available for selection has been thoroughly investigated for quality assurance, thus are all highly rated four star charities. In preferred embodiments, to select a charity option 18, a user of this process clicks on an image or link associated with the charity of choice using the trackpad/mouse 12A and cursor 12B. FIG. 4B depicts a diagram of a charity landing page 18A of a chosen charity option 18, from the perspective of a user of this invention. Additional information and imagery provided on individual charity landing pages 18A are specific to the corresponding individual charities of the same designation. Clearly stated and quite noticeably placed on individual charity landing pages 18A are buttons 18B. The button 18B on the laptop 10 screen showed in FIG. 4B is clearly designated to confirm the selection of a particular charity and is activated by using the trackpad/mouse 12A and cursor 12B to click the button 18B. The drawing presented in FIG. 4 show some of the same elements noted as 10, 12, 12A, and 12B in the previous paragraph and figures in regards to laptop/computer and mouse/trackpad properties, functionality information and the like, thus thorough repetition of these elements will be generally refrained from to prevent redundancy.

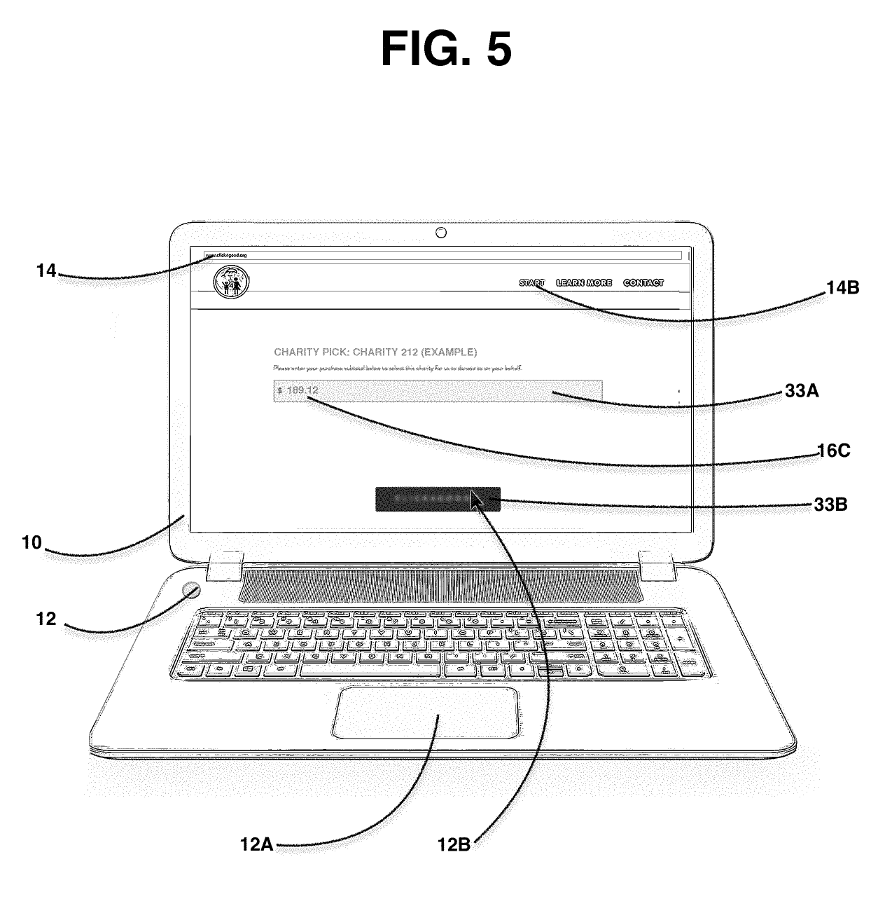

The next figure, FIG. 5, illustrates a diagram of a laptop 10, from a frontal perspective view, displaying one example of the present invention according to various elements and embodiments described herein. FIG. 5 represents the final step to completion of this present process by way of a laptop and directly relates to step 1608 and end point 1609 of the flow chart of FIG.1. Depicted on the laptop 10 screen is an field (area) 33A to enter information in, a confirmation button 33B and the subtotal 16C as seen in FIG. 3, and discussed in other preceding figures, embodiments and paragraphs. Correlating to step 1608 of FIG.1, a user of this invention/process now pastes (keyboard buttons: command+V) or manually enters the copied/noted the purchase subtotal 16C in the field 33A provided. Next, using the trackpad/mouse 12A and cursor 12B, click the button 33B to finalize the selection. The button 20B on the laptop 10 screen showed in FIG. 5, is clearly designated to confirm the selection of a particular charity and is activated by using the trackpad/mouse 12A and cursor 12B to click the button 18B. The alternative manner of completing this process, on a laptop computer, has now been fully explained. The drawing presented in FIG. 5 show some of the same elements noted as 10, 12, 12A, and 12B in the previous paragraph and figures in regards to laptop/computer and mouse/trackpad properties, functionality information and the like, thus thorough repetition of these elements will be generally refrained from to prevent redundancy.

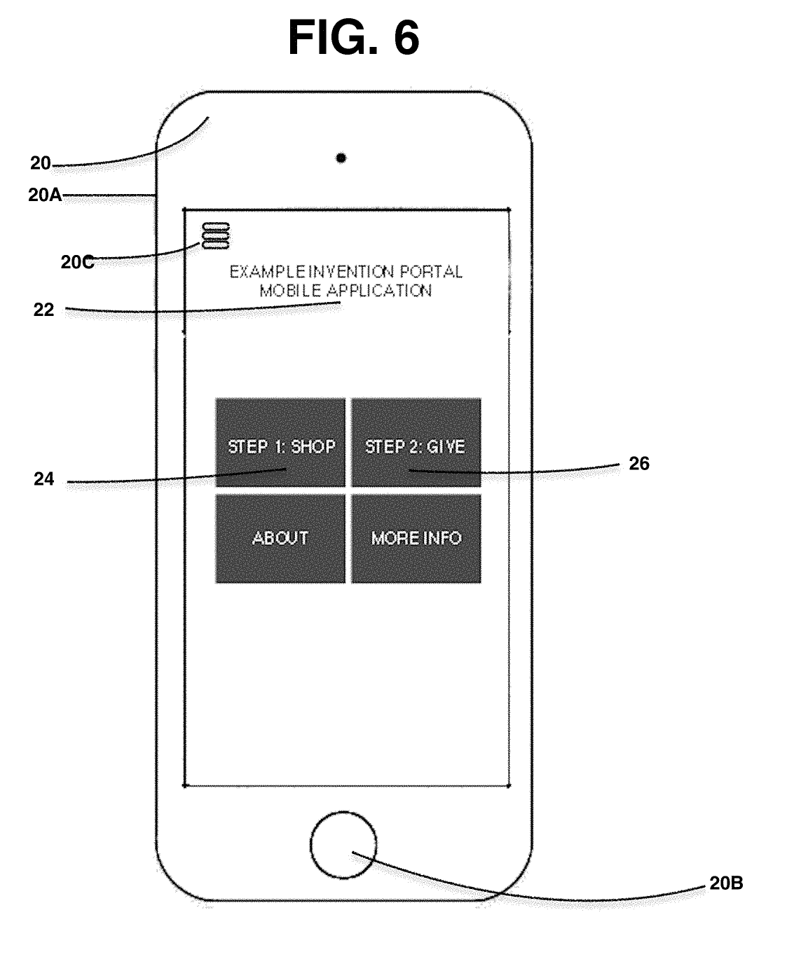

FIG. 6 depicts a diagram of a smart phone, from a frontal perspective view, displaying one example of the present invention according to various elements and embodiments described herein. Depicted on the screen of the smart phone, is a mobile application 22, which makes the invention is accessible to users. In all accompanying figures and drawings, the smart phone 20 is already “powered on” by way of the power button 20A, connected to the internet and has the mobile application, a portal for this invention properly downloaded. Note the power button 20A, as well as other features may be subject to slight variations depending on the brand of smart phone. However most elements in relation to the use of this invention are universal on all smart phone devices. A common feature on all smart phones is the touch screen which is used by hand to maneuver through applications and select things by pressing, including shopping with affiliates using affiliate links 24. These affiliate links 24 are part of affiliate programs associated with various online stores. These programs help enable this invention to function, as a portion of these funds generated from commissions received from these programs are donated the charities. In preferred embodiments the invention is simple and easy to navigate by using the menu 20C that appears as three bars at the top of the screen, which is generally seen in mobile applications. This menu 20C can be used to find a selection of online stores and charities at any time. FIG. 6 conveys the various embodiments and elements associated with the beginning step of the present process. This figure directly corresponds with step 1602 in the flowchart displayed in FIG. 1, and expresses the visual experience from a user's perspective. The main page of the mobile app 22 has a conspicuously placed menu for convenience. In preferred embodiments a user begins on the main page of the mobile application 22, and presses the designated shopping button 24.

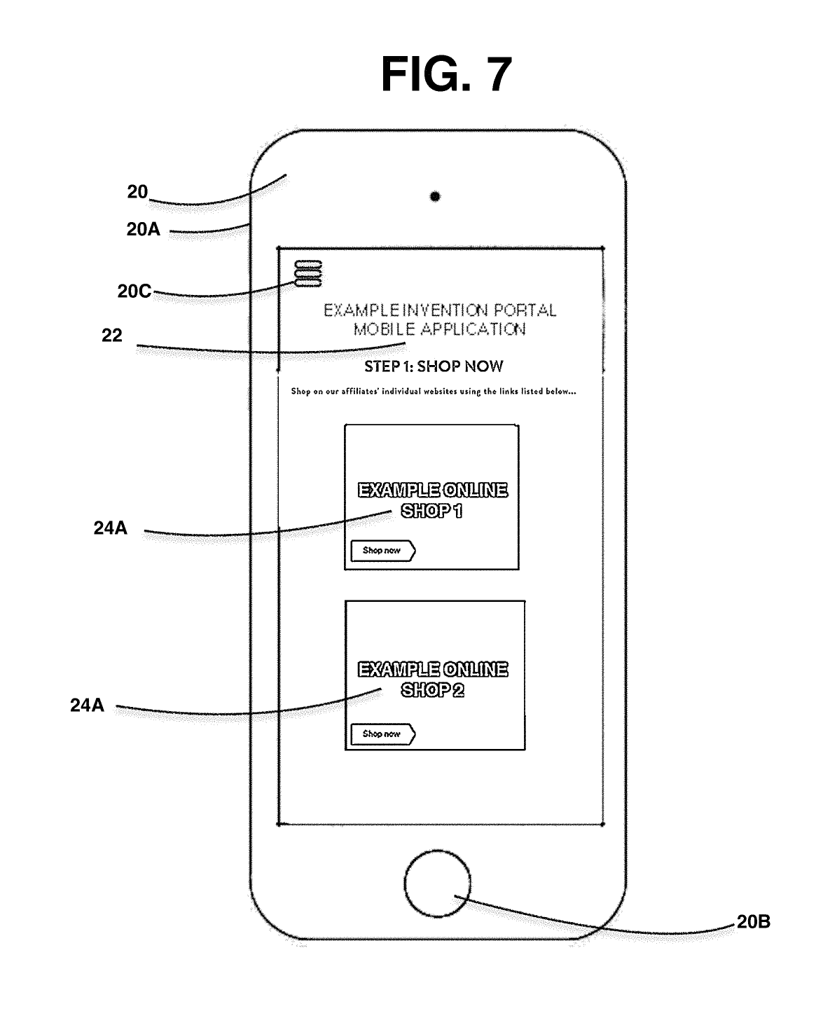

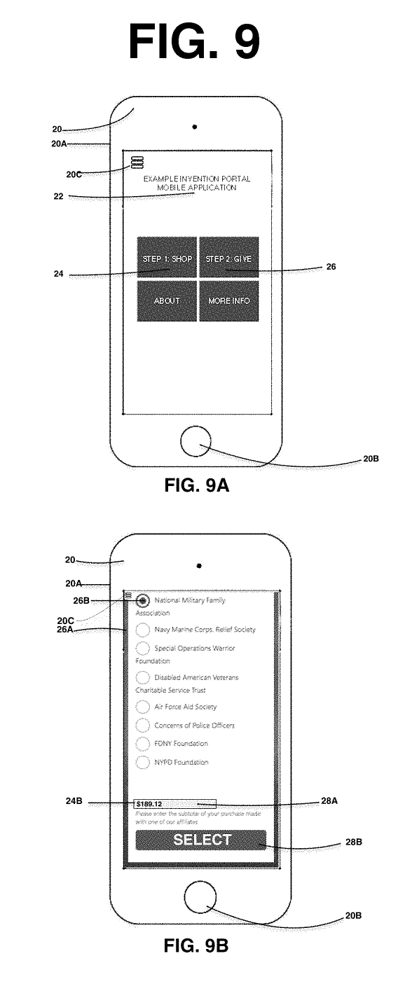

While continuing to express matters discussed in the previous paragraph, FIG. 7 also corresponds directly to step 1603 from the previously displayed FIG. 1 flow chart. FIG. 7 displays a diagram of a smart phone, from a frontal perspective view, displaying one example of the present invention according to various elements and embodiments described herein. Depicted on the screen of the smart phone, is a mobile application 22, which makes the invention is accessible to users. Also depicted on the screen is a variety of online stores/affiliate links 24A. Next in the present process, a user selects a online store 24 from the conspicuously options provided in the form of aforementioned affiliate links 24A. A user clicks on one of these affiliate links 24, to proceed to the next step of the present invention. In preferred embodiments of the present process, an individual consumer selects an online store/affiliate to shop by pressing a affiliate link 24A. After pressing on the affiliate link 24A, add one or more items to the cart, then proceed to checkout. The drawing presented in FIG. 9 show some of the same elements noted as 20, 20A, and 20B in the previous paragraph and figures in regards to general smart phone properties, functionality information and the like, thus thorough repetition of these elements will be generally refrained from to prevent redundancy.

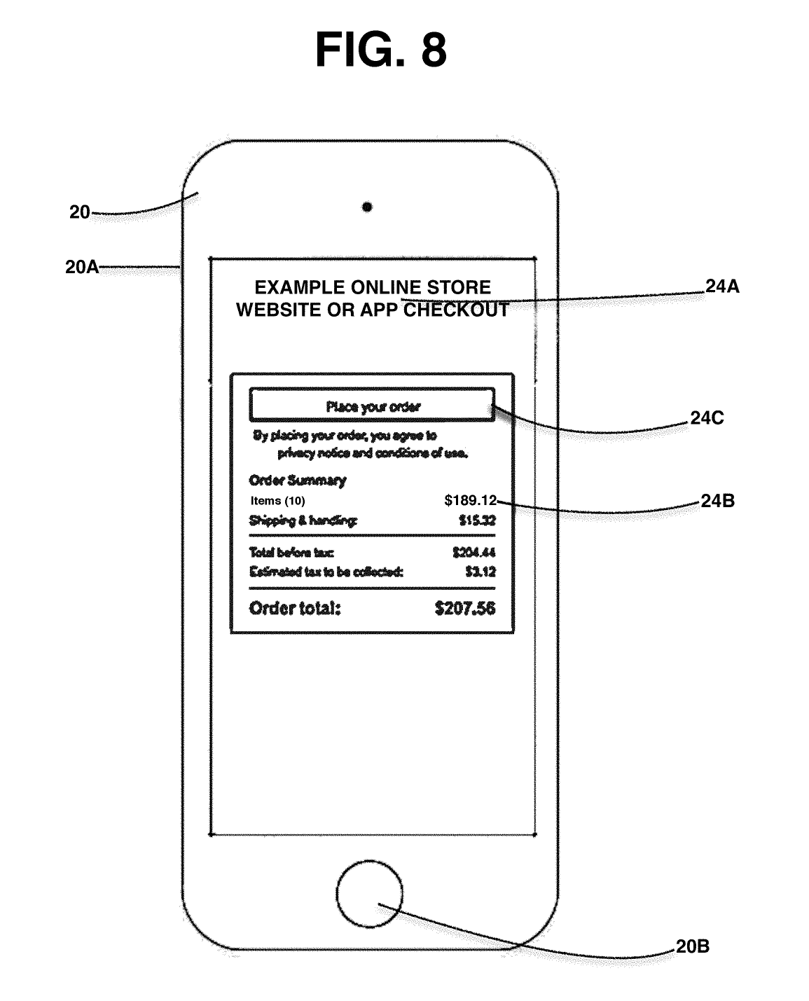

This figure, FIG. 8 displays a diagram of a smart phone 20, from a frontal perspective view, displaying one example of the present invention according to various elements and embodiments described herein. This figure is also noteworthy because in addition to it's correspondence with step 1603 in FIG. 1, it also directly connects to stage 1604, and step 1605, from the same figure. In preferred embodiments of the present process, an individual consumer selects one or more products to purchase from the online store of the affiliate link 24A chosen/clicked on in the previous figure, FIG. 7. Shown on the screen of the smart phone 20, is an embodiment of a affiliate website/app and it's corresponding checkout page 24A. All normal features expected of a general online checkout page are included such as the “Place Your Order” button 24C and order subtotal (cost of items) 24B. Now relating to stage 1604 from FIG. 1, there's two options for an individual at this stage of the process. The present process can either be concluded following checkout, or it can proceed further based on a user's preferences. If a individual selects to conclude this process at this stage, checkout (payment for one item or more), is required. Confirming the purchase by clicking the conspicuously placed button 24C will conclude the process. Completing the process at this stage results in all charities on the list being donated to equally. The first manner of completing this process on a smart phone, has been described thoroughly and thus will conclude for the time being. To continue the alternative manner of completing this process, continue reading herein. If a individual's preference is to select a individual charity to be donated to, there's some additional steps required. Decision to complete the present process in this fashion, relates directly to step 1605 of the FIG. 1 flow chart. In preferred embodiments, to continue this process and select a single charity, a user must simply use apply light pressure/hold finger down to highlight then copy the order subtotal 24B, or just note it by hand on a piece of paper, right before or following checkout. The subtotal 24B is the cost of the items without taxes or shipping, which affiliate programs do not grant commissions for, thus those costs cannot be included in the donation process. In FIG. 8, the embodiment portrays the online order subtotal 24B as “$189.12” but could be any amount of money. The various embodiments and elements expressed in the upcoming paragraphs relate directly to completion of the present process in this alternative fashion. The drawing presented in FIG. 9 show some of the same elements noted as 20, 20A, and 20B in the previous paragraph and figures in regards to general smart phone properties, functionality information and the like, thus thorough repetition of these elements will be generally refrained from to prevent redundancy.

In preferred embodiments, only three additional steps are required to complete the process in it's entirety, in this alternative manner. FIG. 9 directly connects to step 1606 and 1607 from the flow chart displayed in FIG. 1. Illustrating a diagram two smart phones 20, from a frontal perspective view, FIG. 9 displays two examples of the present invention according to various elements and embodiments. The two examples will be labeled FIG. 9A and FIG. 9B to avoid any possible confusion. FIG. 9A relates directly to step 1606, while FIG. 9B corresponds to step 1607 of the flowchart of FIG. 1. FIG. 9A depicts the main page of the mobile application 22 on the screen of a smart phone 20. In preferred embodiments, an individual consumer proceeds to select a charity by returning to the original mobile application 22, a portal to the present invention, expressed also in a diagram in FIG. 6 and also in step 1602 of the flow chart in FIG. 1. Various links that are easily perceptible, such as the menu 20C at the top left corner of the app is supplied to quickly alert consumers to the correct area of the website of which to select a charity. After clicking the menu 20C or just selecting the designated select a charity button 26 on the main page 22, a user is presented with a variety of charity options 26B to select from. In FIG. 9B, displayed on the screen of a smart phone 20 are numerous charity options 26B available for selection. Each charity option 26B available for selection has been thoroughly investigated for quality assurance, thus are all highly rated four star charities. In preferred embodiments, to select a charity option 26B, click on multiple choice bullet associated with the charity of choice. FIG. 9B represents the final step to completion of this present process by way of a smart phone and directly relates to step 1608 and end point 1609 of the flow chart of FIG.1. Depicted on the smart phone 20 screen is an field (area) 28A to enter information in, a confirmation button 28B and the subtotal 24B as seen in FIG. 8, and discussed in other preceding figures, embodiments and paragraphs. Correlating to step 1608 of FIG.1, a user of this invention/process now pastes (apply light pressure on field 28A, select “paste” from popup menu) or manually enters the copied/noted the purchase subtotal 24B in the field 28A provided. Next, press the button 28B to finalize the selection. The button 28B on the smart phone 20 screen showed in FIG. 9B, is clearly designated to confirm the selection of a particular charity and is activated by pressing the button 18B. The alternative manner of completing this process, on a laptop computer, has now been fully explained. The drawing presented in FIG. 9 show some of the same elements noted as 20, 20A, and 20B in the previous paragraph and figures in regards to general smart phone properties, functionality information and the like, thus thorough repetition of these elements will be generally refrained from to prevent redundancy.

What is claimed is:

1. The present invention correlates to the method of making practical and effective use of eCommerce for the generation of donations to highly rated charities. Furthermore, this invention more specifically relates to the process of enabling consumers to act as catalyst for generating monetary donations to highly assessed charities, simply by shopping online by way of this particular process.

2. The invention is a process that utilizes eCommerce to donate to charity through the use of affiliate programs.

3. The present invention enables individual users to shop online by way of desktop computers or mobile devices to generate money that supports a variety of charities or a single charity, if so decided, at no additional cost or fee to the online purchase.
